(19) United States
(12) Patent Application Publication
(10) Pub. No.: US 2017/0334581 A1
(43) Pub. Date: Nov. 23, 2017

(54) Aerial Vehicle Refueling System incorporating a Universal Refueling Interface

(71) Applicants: Michael White, Amherst, MA (US); Miles Austin, (US)

(72) Inventors: Michael White, Amherst, MA (US); Miles Austin, Colorado Springs, CO (US)

(21) Appl. No.: 15/160,071

(22) Filed: May 20, 2016

(51) Int. Cl. B64F 1/36; B60L 11/18; H01M 2/10; B64F 1/04; B64F 1/28; B64C 39/02

(52) U.S. Cl. CPC B64F 1/36; B64F 1/28; B64C 39/024; H01M 2/1083; B64F 1/04; B60L 11/1822; B60L 2200/10; B64C 2201/042; H01M 2220/20; B64C 2201/08

(57) ABSTRACT

A system for autonomously replacing batteries or fuel cells on small aerial vehicles such as Unmanned Aerial Vehicles (UAVs) or radio-controlled aircraft (RC) is described. At the core of this system is a “universal battery receptacle” that can be added to a variety of unmanned aircraft platforms and provides a uniform interface for battery or fuel cell replacement in the form of a commensurately designed “universal fuel cell”.

Additionally, a system is described through which an aerial vehicle can be accepted, manipulated, the batteries replaced, and the vehicle re-launched, all without direct user intervention. Such systems can be deployed across a geographic area to increase the range of aerial vehicles without extensive ground support personnel.

### FIELD OF THE INVENTION

This invention relates to the automated or autonomous replenishment of batteries, fuel cells, fuel, or other power sources for aerial vehicles, especially small, unmanned aerial vehicles (UAVs) and remote control (RC) aircraft.

### BACKGROUND OF THE INVENTION

Currently there is significant interest in using UAV's (sometimes called “drones”) for local and municipal activities ranging from package deliveries to rapid medical response, to surveillance to traffic control. There are many companies creating UAV systems for this application, including battery systems and fuel cell systems for UAV power. However, the range of continuous flight for such systems is necessarily finite, and eventually refueling is required to continue flight or return to a home base. In this way, UAV air traffic is very similar to manned commercial air traffic, where commercial airports serve as refueling and unloading depots for a wide variety of aircraft. A similar refueling platform is required for UAV traffic.

The benefit of UAVs in many applications is the elimination of delivery personnel and the reduction of conventional fuel required to cover short distances. Currently trucks and automobiles are typically used for deliveries and rapid on-scene response of many kinds, requiring full-time operators. The increase in traffic and pollution associated with these modes of transportation further reduce efficiency and drive up costs. UAV's can provide an alternative, but the balance of UAV power and energy sources, such as batteries, currently necessitates a short range (about 10 miles) of flight before refueling.

UAV package delivery applications depend on large serviceable populations within flight range of a UAV fleet. Further, such a UAV fleet must generally depart from a central hub or warehouse to capitalize on economies of scale. Therefore, the ability to boost the UAV flight range in areas around a distribution hub, without significantly adding to the maintenance workforce, could provide direct benefits to such applications.

A device that enables largely automated to autonomous refueling of a large variety of UAV platforms is needed to realize the potential benefits of UAV services. While many manufacturers are creating UAV systems, the power delivery mechanism is remarkably consistent, consisting of some configuration of rechargeable DC battery cells, though the exact mechanical, electronic, and visual configuration of these cells varies greatly. This suggests great potential of a uniform design for batteries and refueling hardware, similar to the standardization of fuels and associated refueling equipment in the commercial aviation and automotive industry.

A device that interfaces with a broad range of UAV designs and enables rapid refueling at a standardized “UAV filling station” is a necessary enabling technology for emerging small aerial vehicle services.

### BRIEF DESCRIPTION OF DRAWINGS

FIG. 1 is a notional design of an embodiment of the “universal battery receptacle” device, in this instance integrated into the UAV landing skids installed on an example UAV;

FIG. 2 is more detailed view of the battery compartment and battery in one nacelle of the universal battery receptacle in the landing skid;

FIG. 3 shows a notional mechanical system for gripping and replacing universal fuel cells in the battery receptacle;

FIG. 4 shows a notional mechanical system for autonomous replacement of UAV fuel cells, enabled by the universal battery receptacle.

### DETAILED DESCRIPTION

A battery receptacle is described that is adaptable to a wide variety of aerial vehicle platforms. The receptacle includes a port or ports for standardized fuel cell modules, which could be DC chemical batteries, hydrogen fuel cells, gas fuel cells (such as butane), or liquid fuel cells. The fuel cell is packaged to insert and lock into the receptacle, and for removal and replacement by a robotic arm or similar tool. The standardized receptacle and fuel cell modules together therefore constitute a “universal refueling interface”.

The universal battery receptacle provides a standardized apparatus for integrating fuel cells into numerous aerial platforms. The receptacle also has a physical design that enables automated interfacing, handling, and grasping of the UAV for fuel cell replacement and other ground support activities.

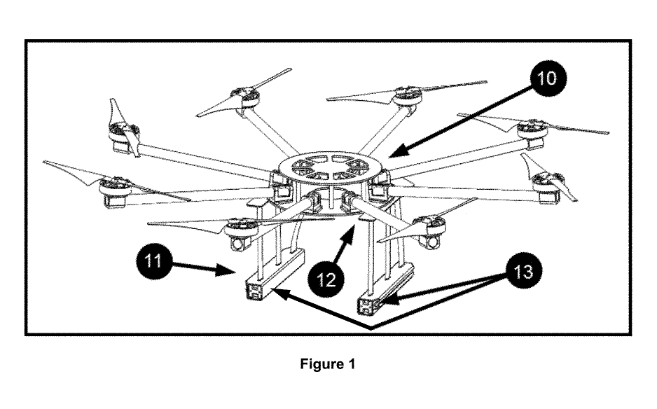

Referring now to FIG. 1 one embodiment of the device is shown mounted to an example UAV system, similar to multi-rotor systems currently under testing for commercial and municipal applications. However, it should be noted that the aerial vehicle itself is not necessarily part of the invention. Here, the universal receptacle is built into the landing skid and is intended to allow standardization across a wide variety of aerial vehicle product designs. In the shown embodiment, the UAV 10 is mounted to a very low-weight universal landing skid system 11. The mounting plate 12 is designed to easily adapt to a wide variety of aerial vehicles. At the bottom of the landing skid, are two nacelles 13, which hold universal fuel cell modules. The area between the nacelles could be used for carrying cameras, packages or other payloads. The intention of this embodiment is to provide a standardized power architecture that is widely applicable to aerial vehicles, and also well suited for automatic or autonomous handling and cell replacement.

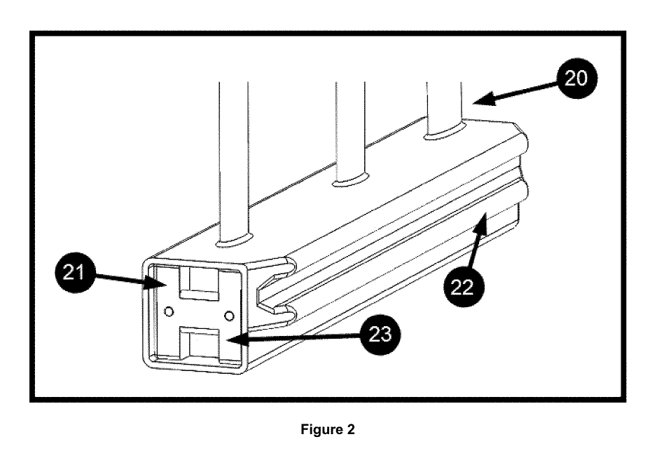

Now referring to FIG. 2, the same embodiment is shown as in FIG. 1, but focusing on a single receptacle, here conforming to the vehicle's left landing skid nacelle from the prior figure. The receptacle is attached to the other landing skid elements by lightweight struts 20, which could be hollow or a lightweight solid, metal or plastic. Inside the receptacle shell is the universal fuel cell 21. The fuel cell is generally envisioned as a battery for current UAV technologies, but generalizable to a variety of energy storage technologies. The face of the fuel cell enclosure 23 can include slots and pins for grasping and simultaneously releasing spring-loaded or magnetic catch mechanisms that serve to firmly connect the fuel cell into the receptacle during flight. In addition, the receptacle design can also include mechanical structures 22, which facilitate grasping and moving the UAV by automated machinery such as arms, pushers, and conveyors. This nacelle embodiment provides a standardized way of landing, manipulating, and refueling a wide variety of aerial vehicles, as UAV technologies proliferate and mature. The intention of this embodiment is to indicate how a specially engineered fuel cell, such as a battery, and robotic arm or similar tool can enable automatic or autonomous extraction and manipulation of the fuel cell for refueling a variety of aerial vehicles, such as a UAV's, fitted with the universal receptacle.

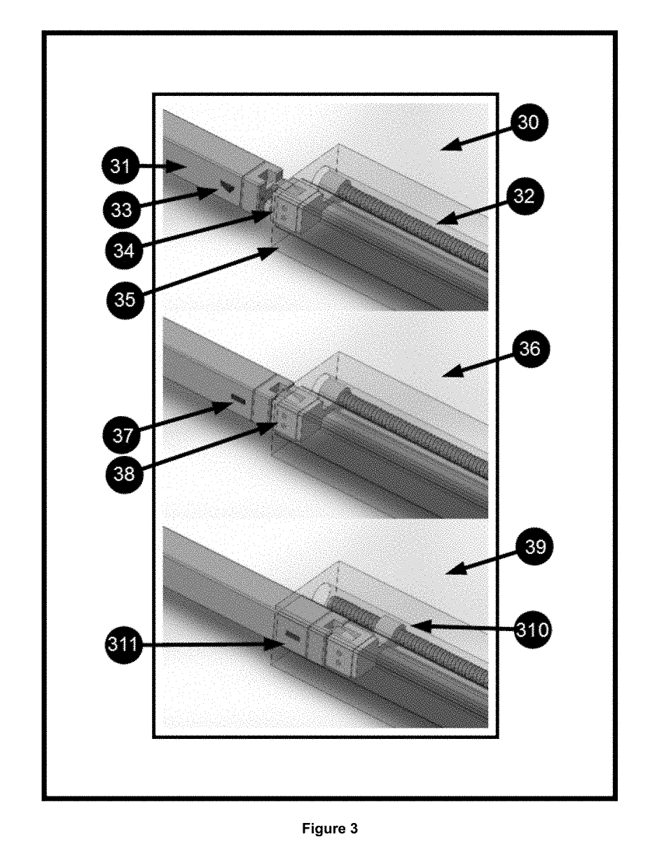

FIG. 3 shows one embodiment of the device is depicted wherein a robotic arm is used to grasp and extract a universal fuel cell. Grasping and pulling progresses in time from the top frame 30 to the bottom 39. In the first instance 30 the arm 35 and screw mechanism 32 advance the claw 34 towards the fuel cell 31. The claw grasping mechanism and the battery face have been designed to mate, and the fuel cell also has a latch mechanism 33 that would be extended to lock the fuel cell into the nacelle (not shown) prior to grasping. In the next instant 36, the claw mechanism 38 has attached to the battery and the latch mechanism 37 is depressed, allowing the fuel cell to be removed from the receptacle (not shown). In the final instant 39, the arm and drive screw mechanism 310 draws the universal fuel cell 311 out of the receptacle and into the arm for transport away from the UAV landing skid, perhaps to a recharging station. Importantly, the instants shown can be visualized in reverse to indicate the replacement of a new, fully charged fuel cell back into the aerial vehicle receptacle on the landing skid prior to departure of the UAV from an automated battery vending system.

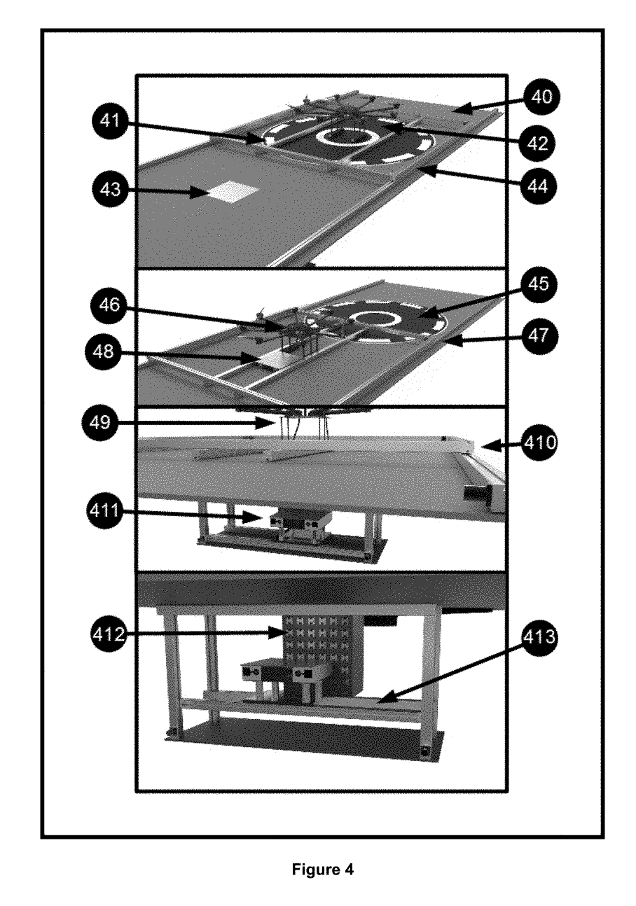

Referring now to FIG. 4, a more extensive embodiment of the device is shown wherein a robotic airport system is used to receive a UAV, align it for refueling, grasp and extract a universal fuel cell, store the extracted fuel cell in a charging station, and select a new or fully charged fuel cell for insertion into the UAV universal receptacle to refuel it. The action illustrated progresses in time from the top frame to the bottom. Importantly, the instants shown can be visualized in reverse to indicate the replacement of a new, fully charged fuel cell back into the aerial vehicle for refueling and return to the landing pad for departure. In the first instance an automated landing pad system 40 receives the UAV 42 and a turntable assembly 41 aligns or orientates the UAV for grasping by an automated gantry system 44. This is accomplished with the aid of machine vision software or other orientation detection devices. The gantry system could be screw-driven or pneumatic and serves to grasp and move the UAV to the battery dispenser port 43. In the next instant, the UAV is grasped by the gantry system 47 and conveyed across the landing pad system 45. The battery dispenser or “vendor” 48 raises to address the fuel cells in the universal battery receptacle, here in the UAV landing skid. In the next instant, the UAV and its battery receptacles 49, now empty of batteries is held by the gantry 410, while the battery vendor robot 411 places the recently removed batteries into a battery charging array located beneath the landing pad system. In the final instant, the battery vendor gantry system 413 propels the vendor robot to select new batteries from the charging array 412. Fully charged batteries can be selected from the array and inserted into the universal battery receptacle, effectively refueling the UAV. Reading back up the frames, the UAV can then be conveyed back to the landing pad, where it can depart the system and resume its mission.

In some embodiments, the universal battery receptacle can be an integral part of a UAV design. In this way the balance and power requirements can be optimized for a specific airframe or application.

In some embodiments, the universal battery receptacle can be a separate mechanical assembly, suitable for retro-fit on a variety of existing UAV platforms. In this way existing UAV products can be made suitable for use with universal fuel cells and associated refueling systems.

In certain embodiments, the universal fuel cell could represent a standardized package envelope, with locking mechanisms and other specifics, but differing in energy storage technology. The fuel cell could be direct current (DC) chemical batteries, hydrogen fuel cells, gas fuel cells (such as butane), or liquid fuel cells. The energy vending system could choose the proper fuel cell technology for a particular UAV that arrived at an automated landing pad.

In some sensor-embedded embodiments, additional data about the UAV and its owner could be determined based on markings or coding on The landing skids, or through direct communication with the UAV. Additionally, the fuel cells can be coded to provide information about, source, lifetime, and ownership.

In some embodiments, the automated landing pad can be an indoor facility that protects the UAV from the elements and enables landing in still air by blocking wind.

In some sensor embodiments, aerial vehicles that enter a landing pad but are not authorized to do so can be mechanically rejected from the landing pad area, thereby not occupying the system and preventing an authorized UAV from landing. Similarly, UAVs that have been refueled, but cannot or will not leave the landing pad on their own power, can be mechanically rejected from the system onto a separate area until they are ready to resume their mission, thereby not occupying the system and preventing continued refueling of air vehicle traffic.

In some embodiments, other grasping and conveying mechanisms including but not limited to conveyor belts and robotic arms can be used, rather than the indicated gantry system in FIG. 4 (44). Similarly, the vendor robot depicted in FIG. 4 (411) is based on current-art vending systems for data storage and retrieval, and other battery extraction, conveying, and replacement strategies are possible.

What is claimed is:

1. A method of standardizing the battery receptacle over a range of aerial vehicle designs such that a single refueling platform can be used to service a range of vehicles and applications;
where it is understood that “battery” in this sense could represent a variety of aerial vehicle energy storage methods (DC chemical cell, hydrogen fuel cell, combustible gas, etc.) in a standardized package.

2. A method for standardizing aerial vehicle energy storage devices such that autonomous or largely automated refueling of a variety of vehicles is enabled.

3. A method of establishing an automated or autonomous landing pad system that accepts, refuels, and re-launches small aerial vehicles that are equipped with a universal battery receptacle or receptacles.

4. A method of claim 1 wherein a standardized fuel cell housing is used for automated extraction and replacement of universal fuel cells.

5. A method of claim 1 wherein any one of many fuel cell designs, technologies (battery chemistry or liquid fuel), or specifications (such as weight and cost) are standardized for automated refueling of aerial vehicles.

6. A method for claim 2 wherein the universal battery receptacle provides both energy storage access and mechanical interfacing to a handling system for small aerial vehicles.

7. A method of claim 2 wherein data associated with the aerial vehicle, its history, or energy consumption is stored or coded into the battery receptacle for enabling automated handling, refueling, or control.

8. A method for claim 2 wherein the universal battery receptacle enables automated vending of fuel to a small aerial vehicle.

9. A method of claim 3 wherein an aerial vehicle is recognized and accepted for refueling based on communicated information such as ownership, account status, and vehicle design.

10. A method for claim 3 wherein the automated refueling pad is an indoor facility that protects aerial vehicles from weather and elements prior to, during, and/or after refueling or handling.

11. A method of claim 3 wherein a plurality of automated refueling platforms are installed across a geographic area, thereby expanding the range of aerial vehicles.

12. A method of claim 3 whereby the automated refueling platform could optionally be mounted on a wheeled base that would enable its transport and relocation.
